(19) United States
(12) Patent Application Publication
(10) Pub. No.: US 2012/0325740 A1
(43) Pub. Date: Dec. 27, 2012

(54) ORGANISM METABOLITES FOR REMOVAL OF POLLUTANTS FROM BRINE

(75) Inventor: Ezekiel Kruglick, Poway, CA (US)

(73) Assignee: EMPIRE TECHNOLOGY DEVELOPMENT LLC

(21) Appl. No.: 13/319,517

(22) PCT Filed: Feb. 14, 2011
(86) PCT No.: PCT/US2011/024715

§ 371 Date: Nov. 8, 2011

(51) Int. Cl. C02F 3/34; C02F 1/62

(52) U.S. Cl. 210/615; 210/730; 210/192; 210/601

(57) ABSTRACT

This disclosure relates generally to methods, apparatuses, and cellular compositions and cellular products for purifying environmental liquids, such as wastewater and brine, using halophilic bacteria that produce, or can be made to produce, siderophore metal chelators.

### TECHNICAL FIELD

This disclosure relates generally to methods, apparatuses, and compositions for purifying environmental liquids, such as wastewater and brine, using bacteria and bacterial cell products.

### BACKGROUND

The following description is provided to assist the understanding of the reader. None of the information provided or references cited is admitted to be prior art.

Many sectors of industry produce highly saline wastewater, which can be harmful to aquatic life, agriculture, and subsequent water usage. It has been reported that the consumption of sodium chloride by industry sectors such as the chemical industry, road-deicing industry, food-processing industries, and agro-food industries exceeds 30 million tons per year. See Lefebvre and Moletta, Water Research, 40, p. 3671-3682 (2006). Consequently, the U.S. government and the European Union, among others, have proposed and passed stringent legislative guidelines and requirements concerning purification of hypersaline waters and wastewaters in order to remove contaminating salt and sodium metals.

Removing heavy metals from brine is typically done using washing solutions of hydrochloric or other acid to reduce the pH to around 1, then mixing and removing solids to remove the heavy metals. This uses large amounts of consumable chemicals and leaves a highly acidic solution to be further processed. See, for instance, U.S. Pat. No. 4,710,367. Sewage sludge removes 5-20% of heavy metals in the primary sedimentation basin and then 10-80% in the activated sludge process.

### SUMMARY

In one aspect, the present technology provides methods useful to remove metals from a liquid. In one embodiment, the method described herein is for removing metals from a liquid, comprising flowing a liquid over and through a region of immobilized bacteria that secrete siderophores, which are carried away from the immobilized bacteria by the flow of the liquid, and which chelate metal ions present in the liquid to form a siderophore-metal complex; and removing the siderophore-metal complex from the liquid. In one embodiment, the liquid is wastewater. In another embodiment, the wastewater is brine or hypersalinated water.

In another embodiment, the bacteria are halophilic bacteria. In another embodiment, the bacteria is an enteric bacteria.

In another embodiment, the siderophore is enterobactin. In another embodiment the cells of the halophilic bacteria are recombinantly engineered to express a different siderophore or a different level of siderophore than is normally expressed in cells of a non-recombinant bacteria.

In another embodiment, the siderophore is selected from the group consisting of enterobactin, enterochelin, aerobactin, agrobactin, pyochelin, pyoverdine, pseudobactins, ferribactin, schizokinen, arthrobactin, α-e-bis-2,3-dihydroxybenzoyllysine, ferrioxamines, and mycobactins, siderophores

In another embodiment, the siderophore is selected from the group consisting of ferrichromes, copragen, rhodotorulic acids, and hydroxamate type, siderophores.

In another embodiment, the region of immobilized bacteria is located in a bioreactor. In another embodiment, the flow of the liquid passes through the bioreactor and into a separate vessel or purification system in which metal ions present in the liquid chelate to the secreted siderophores.

One aspect of an apparatus described herein is a wastewater treatment system, comprising an inlet to a bioreactor that comprises halophilic bacteria that secrete siderophores, and an outlet from that bioreactor. Another method described herein is for removing metal ions from brine, comprising passing wastewater through a bioreactor that comprises siderophore-secreting halophilic bacteria, wherein the outflow of brine from the bioreactor contains secreted siderophores that chelates sodium metal ions, and removing the sodium-siderophore chelated complex from the outflowing wastewater.

Another aspect of the present technology is a kit comprising a vial of halophilic bacteria cells and instructions for culturing the cells. Such a kit may contain vials of appropriate nutrients or nutritional buffers helpful for growing and sustaining the cells. A kit may contain different vials for different species of halophilic bacteria, such as those described herein, as well as others. Alternatively, one kit may contain vials of only one type of species of halophilic bacteria. A kit may also contain Polymerase Chain Reaction primers, oligonucleotides, and probes for amplifying, cloning, and identifying nucleotide sequences that encode for siderophore peptides, which can be used to engineer halophilic bacteria for recombinant production of particular types of siderophore peptides. Alternatively, a kit may also contain a vial of pre-made and purified siderophores. Such “kits” can be scaled to provide for larger quantities, e.g., multiple liters, of cells and siderophores.

A kit may also include a component of a vessel, such as a bioreactor, or a bioreactor itself, that is already loaded or immobilized with halophilic bacteria.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE FIGURES

FIG. 1. Schematic diagram illustrating the flow of liquid that contains metal ions (black filled circles) into a chamber, such as a bioreactor, in which halophilic bacteria (black squares around perimeter of inner surface) are immobilized to the inner surfaces of the bioreactor chamber. These bacteria produce siderophores (open-circles) within the chamber, which subsequently bind to, or chelate to, the metal ions to form complexes. These complexes then pass through the an outlet and are subsequently removed from the outflowing liquid. The remaining liquid is thereafter free of metal ions.

### DETAILED DESCRIPTION

In the following detailed description, reference may be made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented here.

Generally speaking, the method presented here is renewable and environmentally sound because it makes use of halophilic bacteria that, unlike other bacteria, thrive in high salt environments, and which produce metal chelators called siderophores that can be used to complex with metals present in wastewaters. These complexed metals can then be filtered away from, or otherwise removed from, the wastewater, thereby purifying it.

As used herein, unless otherwise stated, the singular forms “a,” “an,” and “the” include plural reference. Thus, for example, a reference to “a protein” includes a plurality of proteins.

As used herein, the term “about” will be understood by persons of ordinary skill in the art and will vary to some extent depending upon the context in which it is used. If there are uses of the term which are not clear to persons of ordinary skill in the art, given the context in which it is used, the term “about” in reference to quantitative values will mean up to plus or minus 10% of the enumerated value.

The present methods described herein are novel ways of removing metal ions from any aqueous liquid, such as water, by using microorganisms that produce siderophores. Halophilic bacteria are one example of such microorganisms that naturally produce siderophores. Fungi are another microorganism that produce siderophores. See, for instance, J. B. Neilands (1952), J. Am. Chem. Soc 74: 4846-4847; J. B. Neilands (1995), J. Biol. Chem. 270: 26723-26726; and Cornelis & Andrews (editor) (2010). Iron Uptake and Homeostasis in Microorganisms. Caister Academic Press, which are all incorporated herein by reference. Grasses, such as poaceae grasses, also are known to produce siderophores called phytosiderophores and mugineic acid siderophores. Accordingly, the present technology is not limited to the use of only halophilic bacteria. Thus, to the extent there are citations herein to the use of halophilic bacteria in methods and compositions of the present technology, they are illustrative and non-limiting embodiments. As is clear elsewhere in this application, siderophores can be produced by a variety of microrganisms and therefore reference to a halophilic source of siderophores is illustrative.

Accordingly, the present technology uses siderophores produced from microorganisms to chelate metal ions present in an aqueous medium. The medium may be continuously flowing over or through immobilized microorganisms such that the siderophores that the microorganisms secrete travel with the flowing medium away from the immobilized microorganism to chelate metal ions effectively “downstream” of the microorganisms that produced them. Thus, envisioned in the present technology is a compartment or vessel or porous surface or filter or membrane, in which, or onto which, are contained microorganisms, such as halophilic bacteria. It is desirable that the microorganisms are immobilized, suspended or otherwise retained in that discrete area, which is itself kept in an environment that permits the microorganisms to survive and produce siderophores. An aqueous medium then can be poured through, over, or into the microorganism-containing area, such that secreted siderophores in, for instance, the compartment or filter, are carried away with the aqueous medium as it flows away. Thus, for instance, wastewater can be flowed through a chamber in which is contained filters of immobilized halophilic bacteria in order to chelate to metal ions present in that wastewater. The resultant siderophore-metal ion complex can then be removed from the liquid by filtration or flocculation and thereby produce treated water that contains fewer contaminating metal ions than it contained prior to treatment.

Alternatively, an amount of aqueous medium can be added into a vessel that contains a culture of immobilized siderophore-producing microorganisms for a period of time and then poured out, or otherwise removed, such that any siderophore-metal chelated complexes can be separated by filtering the medium or centrifuging it. For instance, all or some of a liter of wastewater could be poured into a beaker containing immobilized halophilic bacteria cultured in some amount of liquid that is in the beaker. That liquid contains secreted siderophores. Similarly, if the vessel has an exit port, or outflow, that allows the vessel to be drained, then this also permits the removal of liquid containing secreted siderophores. Thus, such a system can optionally be regarded as an “in line” system, but one that facilitates batch processing.

After the wastewater has been poured into the beaker, or otherwise removed, it may be stirred, agitated, or swirled for a period of time, e.g., for 1-5 minutes, 5-10 minutes, 10-30 minutes, 1 hour, or more than 1 hour, to permit the secreted siderophores to chelate with any metal ions present in the wastewater. The contents of the beaker can then be poured into another beaker through one or more filters that prevent the chelated siderophore-metal complexes from passing through. Alternatively, the contents of the beaker may be centrifuged and the supernatant subsequently separated from pelleted siderophore-metal complexes.

Any aqueous medium can be treated according to the methods described herein and using the halophilic compositions described herein, such as siderophores, microorganisms immobilized or affixed onto a surface, such as a filter, and vessels or chambers into which such microorganisms can be immobilized or retained. Bacteria can also be immobilized on beads which are added to aqueous medium and large enough to be retained within a chamber or filter as the aqueous medium is washed or poured away or otherwise removed from the chamber. As described below, “aqueous medium” includes all sorts of liquids, such as water, rainwater, wastewater, brine, environmental waters such as seawaters, riverwaters, and lakewaters, and also liquids such as buffers and solutions, that can be treated by the siderophore-producing miccororganisms disclosed herein.

It is well known how to immobilize, or entrap, bacteria to surfaces, such as membranes. For example, matrices made of calcium alginate, carageenan, agar, cellulose, polyacrylate, and polyamide, have all been used to entrap bacteria. See Chibata, 1., 1983, Basic Biology of New Developments in Biotechnology, p. 465-496, Plenum Press, New York (Hollaender, Laskin, and Rogers). See also for instance Hyde et al., Immobilization of Bacteria and Saccharaomyces cerevisiae in Poly(Tetrafluoroethylene Membranes, Applied and Environ. Micro., 57(1):219-222 (1991), which is incorporated herein by reference. It also is possible to immobilize bacteria in three-dimensional hydrogel scaffolds. See for instance Gutierrez et al., Chem. Matter, 19(8):1968-1973 (2007). And foams are also well known materials for immobilizing bacteria. For a review of methods for immobilizing bacteria to various materials including polyurethane-based foams, see Santo Domingo et al., Immobilization of Degradative Bacteria in Polyurethane-Based Foams: Embedding Efficiency and Effect on Bacterial Activity, Journal of Industrial Microbiology (Department of Energy), and the references cited therein. It is also well known that bacteria can be immobilized on polyester cloth. See Koziarz & Yamazaki et al., Biotechnology Techniques, 12(5):407-410 (1998).

Accordingly, a structure such as a matrix, membrane, hydrogel scaffold, foam, and cloth, can be used in the present technology as surfaces upon which to immobilize, entrap, or embed a siderophore-producing microorganism. That structure can be placed in the flow of an aqueous medium that is to be treated, or placed in a compartment or chamber through which an aqueous medium is passed through or across. Alternatively, the structure can be placed into a vessel into which is also poured an amount of an aqueous medium and incubated together for a period of time before the liquid is poured off with the structure containing the immobilized bacteria retained in the vessel. However it is accomplished, the present technology encompasses a variety of ways of immobilizing microorganisms, such as halophilic bacteria, to a surface and then using those immobilized microorganisms to produce and secrete siderophores into a liquid through which is passed or admixed the aqueous medium to be treated. The siderophores secreted into the liquid chelate any metal ions present in the aqueous medium, which can then be removed as disclosed elsewhere herein. The present technology also encompasses the use of mixtures of immobilized microorganisms.

In one embodiment, a liquid containing siderophorese can be mixed with, or flowed into, the aqueous medium that is to be treated. Thus, to-be-treated wastewater, for instance, need not flow through or be brought into contact with any area containing immobilized microorganisms. Instead, that wastewater can be treated by adding to it a liquid into which siderophores have been secreted. For example, one vessel may contain immobilized halophilic bacteria and a liquid into which the bacteria secrete siderophores. That siderophore-containing liquid can then be introduced into wastewater in one of several ways. For instance, there may be a controllable or continuous flow or stream of the liquid out of the vessel containing the immobilized bacteria into another vessel or pipe through which flows contaminated wastewater. Alternatively, liquid containing siderophores may be poured from the vessel containing the siderophores and into a vessel containing the contaminated wastewater. This can be done manually or automated. Accordingly, the aqueous medium, such as contaminated wastewater, need not flow through or be contacted with the actual vessel or structure containing the siderophore-secreting siderophores.

Furthermore, bioreactors that contain microorganisms, such as halophilic bacteria, that produce metal-chelating siderophores can be used and installed at point source and non-point source locations, as well as at different stages of conventional water pollution treatments, such as but not limited to primary and secondary stage pollution treatment schemes. A bioreactor in this regard may simply be a chamber or enclosed environment useful for maintaining one or more cultures of siderophore-producing microorganisms. For instance, a membrane bioreactor may be used to culture halophilic bacteria. See Cyplik, et al., Application of a membrane bioreactor to denitrification of brine, Desalination, 207(1-3):134-143 (2007). See also Witzig et al., Microbiological aspects of a bioreactor with submerged membranes for aerobic treatment of municipal wastewater, Water Research, 36(2):394-402 (2002). Corrosion-resistant fermentation and aerated bioreactors for culturing and growing extremely halophilic archea bacteria are also known in the art. See Hezayen et al., Applied Microbiology and Biotechnology, 54(3):319-325 (2000). Another bioreactor used in wastewater treatment is the packed bed bioreactor. See Kariminiaae-Hamedaani et al., Wastewater treatment with bacteria immobilized onto a ceramic carrier in an aerated system, Journal of Bioscience and Bioengineering, 95(2):128-132 (2003). All publications cited are incorporated by reference herein.

Different types of heavy metals can be removed using various types of halophilic bacteria described herein. Moreover, recombinant genetic engineering techniques are described herein for genetically modifying halophilic bacteria to express or overexpress particular or desirable siderophores, which can be isolated from halophilic bacteria and applied directly, in pre-made form, to water; or halophilic bacteria can be grown and sustained in bioreactors described herein that are the initial vessel through which water passes and flows and into which siderophores are constantly secreted. The present description also makes clear that in addition to purifying water by removing metal ions present in the water, the methods disclosed herein can be used affirmatively to collect desired metals from water sources, such as natural and waste waters, and thereby provides a novel method for obtaining metals from water sources. Moreover, the presently described methods and compositions can be used to meet federal and state guidelines for ensuring the purity and metal content of certain waters meet certain required thresholds and limits. Accordingly, a system of methods and biological compositions for removing metals from water is described herein, as is discussed in more detail below, beginning with the types of water that may be purified using the present technology.

1. Water

The present method can be used to purify and remove trace elements, such as heavy metals, from many different types of water. It may be desirable, for instance, to use the disclosed methods to purify natural water that has become polluted with impurities such as heavy metals produced by industry, agriculture, or natural phenomena. Natural waters includes but is not limited to any body of water, rivers, streams, lakes, reservoirs, ponds, canals, localized sea water, such as in a bay or harbor. In addition to “natural” water, the term “water,” as used herein, further encompasses:

(1) waters of aquatic ecosystems, which includes but is not limited to coral reefs, estuaries, freshwater ecosystems, lakes, marine ecosystems, oceans, rivers and streams, watersheds, and wetlands;

(2) drinking waters;

(3) ground waters, such as waters caused by discharge, hydrogeology, runoff, and found in wells;

(4) surface waters that are naturally open to the atmosphere, such as lakes, rivers, seas and reservoirs; and

(5) wastewaters. Wastewater, according to the Environmental Protection Agency, is “the spent or used water from homes, communities, farms and businesses that contains enough harmful material to damage the water's quality.” Wastewater therefore includes both domestic sewage and industrial waste from manufacturing or municipal sources.

Brine water is a particular type of wastewater characterized by high levels, such as saturating levels, of a salt, typically sodium chloride. Hypersaline wastewater can be generated also by industrial waste, such as during the manufacture of chemicals, such as pesticides, pharmaceuticals, and herbicides, and during oil and gas recovery, and also as generated by the food industry (such as the production of brine wastewater from the olive oil industry), and textile industry (such as the production of brine wastewater in the leather- and fur-processing industries). See Ventosa et al., Microbiol. Mol. Biol. Rev., Vol. 62, No. 2, p. 504-544 (1998) at page 536.

Because conventional, i.e., non-halophilic, bacteria are typically unable to survive in high salt environments, the methods disclosed herein are useful for treating brine by using halophilic bacteria and siderophores to chelate to metals in brine to form complexes that can subsequently be removed and filtered away. As discussed below, certain conventional treatment regimes, such as preliminary and secondary wastewater treatments, cause the evaporation of the liquid phase of the treated effluent. This evaporation subsequently results in a significant increase in the brine content of the wastewater. The methods and compositions disclosed herein are therefore useful in various different stages of water purification, such as directly in brine water, and in preliminary and secondary stages of wastewater treatment.

2. Point Source and Nonpoint Source Water Pollution

In terms of pollution-treatment strategies, not only can the classification of “water” be important for devising appropriate purification schemes, but so can the water's source. In the United States, there are two main sources of water: (1) point sources and (2) nonpoint sources. The U.S. Clean Water Act defines “point source” as any discernible, confined and discrete conveyance, including but not limited to any pipe, ditch, channel, tunnel, conduit, well, discrete fissure, container, rolling stock, concentrated animal feeding operation, or vessel or other floating craft, from which pollutants are or may be discharged. This term does not include agricultural storm water discharges and return flows from irrigated agriculture.

The present methods can be used to treat point source, inland brine sources, such as brine that comes up from failed oil well attempts. Such brine can contain 30-to-3,000 times the amount of metal ion content than less salty waters. Therefore the application and installation of the present methods and compositions for removing metals from wastewater, like brine, can be extremely useful at such point source locations.

The term “nonpoint source” is defined to mean any source of water pollution that does not meet the legal definition for “point source”-emanating water. The bacterial-treatment methods disclosed herein can be applied to both point source and nonpoint source waters.

To elaborate, nonpoint source pollution is a leading cause of water quality problems. Nonpoint source waters come from many diffuse sources, such as rainfall or snow and ice melt that moves over and through the ground. As the runoff moves, it picks up and carries away natural and human-made pollutants, finally depositing them into lakes, rivers, wetlands, coastal waters and ground waters. Nonpoint source pollution can include, but is not limited to excess fertilizers, herbicides and insecticides from agricultural lands and residential areas; oil, grease and toxic chemicals from urban runoff and energy production; sediment from improperly managed construction sites, crop and forest lands, and eroding stream banks; salt from irrigation practices and acid drainage from abandoned mines; bacteria and nutrients from livestock, pet wastes and faulty septic systems; and atmospheric deposition and hydromodification.

3. Water Pollution Treatments

1. Preliminary Wastewater Treatment

Preliminary wastewater treatment usually involves gravity sedimentation of screened wastewater to remove settled solids. Any remaining residual material from this process is a concentrated suspension called primary sludge, that can subsequently be subjected to additional treatment to become bio-solids. The methods, bacteria, and siderophores disclosed herein can be used to further treat preliminary wastewater prior to or after gravity sedimentation to remove contaminating metal ions present in it. Thus, for instance, preliminary wastewater can be passed through a compartment containing immobilized halophilic bacteria that secrete siderophores such that the post-treated preliminary wastewater contains chelated metal-siderophore complexes. These complexes can be filtered away from the preliminary wastewater which can then be processed accordingly to remove settled solids according to conventional methods. Alternatively, any remaining residual material may be treated the same way, or any sludge may be diluted or resuspended in an amount of water which is then passed through or across immobilized halophilic bacteria and thereby treated the same way before it is again subjected to gravity sedimentation.

2. Secondary Wastewater Treatment

Secondary wastewater treatment typically removes biodegradable material. This treatment process uses microorganisms to consume dissolved and suspended organic matter, producing carbon dioxide and other by-products. The organic matter benefits by providing nutrients needed to sustain the communities of microorganisms. As microorganisms feed, their density increases and they settle to the bottom of processing tanks, separated from the clarified water as a concentrated suspension called secondary sludge, biological sludge, waste activated sludge, or trickling filter humus. As with preliminary wastewater, the methods, bacteria, and siderophores disclosed herein can be used to further treat secondary wastewater, residue, or any of the consequent suspensions or sludges, to remove contaminating metal ions present in those liquids and materials.

3. Tertiary or Advanced Treatment

Tertiary or advanced treatment is used when extremely high-quality effluent is required, including direct discharge to a drinking water source. The solid residual collected through tertiary treatment consists mainly of chemicals added to clean the final effluent, which are reclaimed before discharge, and therefore not incorporated into bio-solids. Tertiary or advanced treatment does not reduce the treated wastewater brine content, and therefore typically mandates the use of energy-intensive Quaternary brine treatment removal methods such as the use of reverse osmosis and distillation. The methods, bacteria, and siderophores disclosed herein can be used to further treat tertiary or advanced treatment wastewater to remove contaminating metal ions present in it. For instance, water destined for direct discharge can be treated as disclosed herein and metal-siderophore chelated complexes removed by filtration or other method prior to direct discharge to a drinking water source. The treatment of tertiary water with the present technology may take place at any point in the water purification process.

4. Heavy Metals

Examples of heavy metals that can runoff from nonpoint and point sources and pollute water include, e.g., but are not limited to, lead, zinc, iron, copper, manganese, cadmium, vanadium, chromium, nickel, aluminum, gallium, chromium, indium, plutonium, and uranium. The presence of such metals in water, or threshold levels of such metals, can be harmful to human, animal, and crop health if ingested or absorbed. Iron ingestion, for example, can lead to heart disease, cancer, and diabetes; excess mercury in water can lead to loss of muscle control, kidney disease, and brain damage; nickel can be a cause of weight loss, skin irritation, and can cause heart and liver damage; exposure to radioactive water can cause bone and liver cancer, and cause other genetic disorders leading to birth and developmental defects; selenium, at too high a concentration, can cause kidney and liver damage, as well as to the nervous and circulatory systems; thallium overexposure can also cause liver, kidney, intestinal and testicular damage.

5. Halophilic Bacteria

Halophiles are found in many natural saline environments such as the Dead Sea, the Great Salt Lake, solar salterns, and salted foods. These organisms require salt, such as sodium chloride, for sustenance, and will grow poorly, if at all, if placed in dilute ionic solutions. Several unique adaptations allow halophilic bacteria to survive in concentrated salt solutions. First, halophiles accumulate compatible solutes, such as potassium ions, amine acids, and betaine, within their cells that effectively equalize the ionic strength of the cytoplasm and the external environment. Such solute accumulation reduces the osmotic forces that would otherwise desiccate the cell. Secondly, halophiles have proteins and cell walls that contain large numbers of negatively charged amino acids and polar lipids. High concentrations of cations are required to shield negative charges and thereby also stabilize these macromolecules. Finally, the transport of essential nutrients and growth factors is linked to sodium ion gradients that exist in hypersaline environments, which bacteria such as halophiles are able to exploit to survive. Because halophilic bacteria can survive in salt water conditions, they are particularly adept at surviving in brine.

These bacteria have developed a complicated mechanism to get access to normally insoluble environmental heavy metals. They produce families of external complexing agents that they release into the surroundings to make the heavy metals soluble and then use concentration gradients to transport back the heavy metals. One such useful product of halophilic bacteria are siderophores, which are explained in more detail below.

In short, a siderophore is a metal ion-chelating molecule or peptide secreted by the halophilic cell to bind to environmental metals, such as iron ions, and then return to the cell, where the metal required for sustenance is subsequently detached and utilized by the cell. The present methods make use of the halophilic bacteria's ability to naturally produce siderophores that are useful for binding metal ions that contaminate wastewater, such as brine. As also discussed in more detail below, bacteria that are described herein can be genetically modified to overexpress a particular siderophore peptide, or to express numerous different types of siderophores. With respect to the present methods, complexes of siderophore-chelated metal ions can be easily separated from wastewater by, for instance, filtration, settling, or flocculation. Other means for capturing such metabolite complexes are possible too and known to the skilled artisan.

Examples of halophilic bacteria include, but are not limited to, Halobacterium salinarum, Natronomonas pharaonis, Haloquadratum walsbyi, Halorhodospira halophila, and Halobacillus halophilus. Halobacterium salinarum can survive in some of the saltiest places on earth, such as in the Great Salt Lake, the Dead Sea and Lake Magadi, which is located in southern Kenya. It is shaped like a rod, or bacillus, has a distinctive red color, and can live solely off of energy from sunlight. Natronomonas pharaonis also lives in extreme environments, such as in highly salty and highly alkaline waters, such as the soda lakes in Egypt. Natronomonas pharaonis is, however, sensitive to excess magnesium levels. Haloquadratum walsbyi are unusually square, thin, and flat. Like Halobacterium salinarum and Natronomonas pharaonis, Haloquadratum walsbyi is an archaebacteria, which are some of the most ancient organisms on earth. Halorhodospira halophila is a type of purple bacteria that produces hydrogen. Halobacillus halophilus is a eubacteria that commonly resides in salt marshes, such as those near the Northern Sea.

Halophilic bacteria are known to be useful for treating biological waste. See, for instance, Margesin and Skinner, Extremophiles, 5, p. 73-83 (2001). Halophilic bacteria also can degrade organic compounds, such as organophosphorous compounds because of the activity of the endogenous enzyme, organophosphorous acid anhydrase. See Ventosa (supra) at page 536. Also, members of the Halomonadaceae family of halophiles utilize chloroaromatic compounds as sources of carbon and energy and therefore are useful for degrading such contaminating compounds present in wastewater. For example, one halophile in this family has high activities of the enzymes catechol 1,2-dioxygenase, muconate cycloisomerase, and dienelactone hydrolase, which enable that halophile to utilize aromatic compounds such as benzoic acid, 3-chloro-benzoic acid, and 4-chlorophenol.

The types of halophiles that can be used as described herein can be ordered from specialty houses or obtained from academic labs such as those at the University of Notre Dame Center for Bioengineering. Thus, halophilic versions of the bacteria are known to exist and can be easily bred by exposing colonies over time to progressively saltier environments. It may be desirable to retain a growing culture of such bacteria and retain batches of bacteria suitable for a variety of salt environments.

Halophilic aerobic archaebacteria can require various combinations of nutrients to grow, such as various concentrations of sodium chloride, potassium chloride, potassium sulfate, magnesium sulfate, magnesium chloride, calcium chloride, and yeast extract. See for instance Table 3 at page 90 of The Biology of Halophilic Bacteria (Ed. Vreeland and Hochstein) (1992).

More species of halophilic bacteria useful for performing the present methods, and the types of siderophores they produce, are described in the following subsection on siderophores.

The present technology is not limited to the use of only halophilic bacteria. Other microorganisms that produce siderophores may be used as well. For instance, examples of microorganisms that produce siderophores include but are not limited to Ustilago sphaerogena (produces ferrichrome siderophore); Streptomyces pilosus (produces Desferrioxamine B siderophore); Streptomyces coelicolor (produces Desferrioxamines B and E siderophores); Fusarium roseum (produces fusarinine C siderophore); Burkholderia cepacia (produces ornibactin siderophore). These are examples of hydroxamate siderophores. Examples of catecholate siderophore-producing microorganisms include but are not limited to Escherichia coli (enterobactin); Bacillus subtilis (bacillibactin); Bacillus anthracis (bacillibactin); and Vibrio cholerae (vibriobactin). For more information on siderophores see the following subsection.

A microorganism can be cultured in any volume for use in the present technology. For instance, a reasonably dense colony in a 10 liter culture could be expected to remove low parts per million (ppm) metallic material from about 100 million liters to a billion liters in 24 hours. Accordingly, the present technology encompasses cultures of microorganisms, such as halophilic bacteria, of 1-10 L, 10-20 L, 20-30 L, 30-40 L, 40-50 L, 50-60 L, 60-70 L, 70-80 L, 80-90 L, 90-100 L, or more than 100 L. The present technology also can be used to remove 1-100 ppm, 100-200 ppm, 200-300 ppm, 300-400 ppm, 400-500 ppm, 500-600 ppm, 600-700 ppm, 700-800 ppm, 800-900 ppm, 900-1,000 ppm, 1,000-2,000 ppm, 2,000-3,000 ppm, 3,000-4,000 ppm, 4,000-5,000 ppm, 5,000-6,000 ppm, 6,000-7,000 ppm, 7,000-8,000 ppm, 8,000-9,000 ppm, 9,000-10,000 ppm, or more than 10,000-300 ppm of one or more metal materials from an aqueous medium. In this regard, the present technology permits treatment of 1-100 million liters of aqueous medium per unit time, 100-200 million liters of aqueous medium per unit time, 200-300 million liters of aqueous medium per unit time, 300-400 million liters of aqueous medium per unit time, 400-500 million liters of aqueous medium per unit time, 500-600 million liters of aqueous medium per unit time, 600-700 million liters of aqueous medium per unit time, 700-800 million liters of aqueous medium per unit time, 800-900 million liters of aqueous medium per unit time, 900-1,000 million liters of aqueous medium per unit time. The per unit time interval may be 1-12 hours, 1-24 hours, or 24-48 hours. In one embodiment, 1 million to 1 billion liters or more of aqueous medium, such as water, can be treated in one 24 hour period of time using the present technology. In terms of weight, a relatively small volume of microorganisms of the present technology can be used to treat a relatively high amount of aqueous medium. For instance, in one embodiment, 10 L of halophilic bacteria can be used to treat 1-100 billion tons or more of water per day.

6. Siderophores

Siderophores are low-molecular-mass, generally 500-1000 daltons, molecules that chelate, or bind to, metal ions. Siderophores are produced by microorganisms, such as bacteria, e.g., the halophilic bacteria described herein, yeast, and fungi, and generally act as molecular scavengers that isolate metals from the environment and bring them back to the bacterial cell. Metals such as iron are necessary for bacterial cell survival. Thus, siderophores are secreted from microorganisms like bacteria, whereupon they chelate metal ions and then pass back through a cell surface receptor pore into the cell, where the metal ion is subsequently assimilated.

One such important metal ion is iron and many siderophores, such as enterobactin and aerobactin are ferric ion specific chelating agents that tightly bind Fe³⁺ iron. See J. B. Neilands, J. Biol. Chem., Vol. 270, No. 45, pp. 26723-26726 (1995). Other siderophores, such as pyochelin and pyoverdin can bind other transition metals, such as cobalt, nickel, and copper. Visca et al., Applied and Environmental Microbiology, Vol. 58, No. 9, pp. 2886-2893 (1992). More than 500 different siderophores have been identified from microorganisms, and, as mentioned, some bacteria produce more than one type of siderophore. Thus, metals that can be chelated by siderophores include, e.g., but are not limited to, iron, aluminum, gallium, chromium, copper, cobalt, zinc, lead, manganese, cadmium, vanadium, indium, plutonium, and uranium.

Many siderophores produced by microorganisms are nonribosomal peptides, for example, which exhibit a broad range of biological activities and pharmacological properties. Enterobactin, for example, is a catecholate nonribosomal peptide siderophore, produced by enteric bacteria, such as by Escherichia coli. Nonribosomal peptides are synthesized by nonribosomal peptide synthetases independently of messenger RNA. Nonribosomal peptides often have a cyclic and/or branched structures, can contain non-proteinogenic amino acids including D-amino acids, carry modifications like N-methyl and N-formyl groups, or are glycosylated, acylated, halogenated, or hydroxylated. Nonribosomal peptides are often dimers or trimers of identical sequences chained together or cyclized, or even branched. There also exist hydroxamate siderophores and mixed ligand versions, such as azobactin.

In prokaryotes, examples of species and siderophores are: Enteric species (enterobactin, enterochelin, aerobactin); Agrobacterium tumefaciens (Agrobactin); Pseudomonas species (pyochelin, pyoverdine, pseudobactins, ferribactin); Bacillus megaterium (schizokinen); Anaboena species (schizokinen); Arthrobacter species (arthrobactin); Azotobacter vinelandii (α-ε-bis-2,3-dihydroxybenzoyllysine); Acetinomyces species (ferrioxamines); Mycobacterium species (mycobactins).

In eukaryotes, examples of species and siderophores are: Penicillin species (ferrichromes, copragen); Aspergillus species (ferrichromes, copragen), Neurospora (ferrichromes, copragen), and Ustillage (ferrichromes, copragen); Rhodotorula species (rhodotorulic acids); and Ectomycorrhizal species (hydroxamate type). See U.S. Pat. No. 4,530,963, and Lanyi, Bacteriological Reviews, Vol. 38, No. 3, p. 272-290 (1974), which are incorporated herein by reference. Studies also have been done to evaluate halophilic production of siderophores. See, for instance, Dave et al., Indian J. Exp. Biol., 44(4), p. 340-344 (2006).

7. Genetic Modification of Halophilic Bacteria

As mentioned, some siderophores are peptides. This means it is possible to design polynucleotide sequences that can be transcribed and translated inside the cell to produce peptidic siderophores. Such recombinantly engineered halophiles can be used according to the present methods to treat wastewater, such as brine, to remove metal ions. The sequence, for instance, of the siderophore enterobactin (the entF gene of E. coli) is known. See Rusnak et al., Biochemistry, 30(11), p.: 2916-27 (1991).

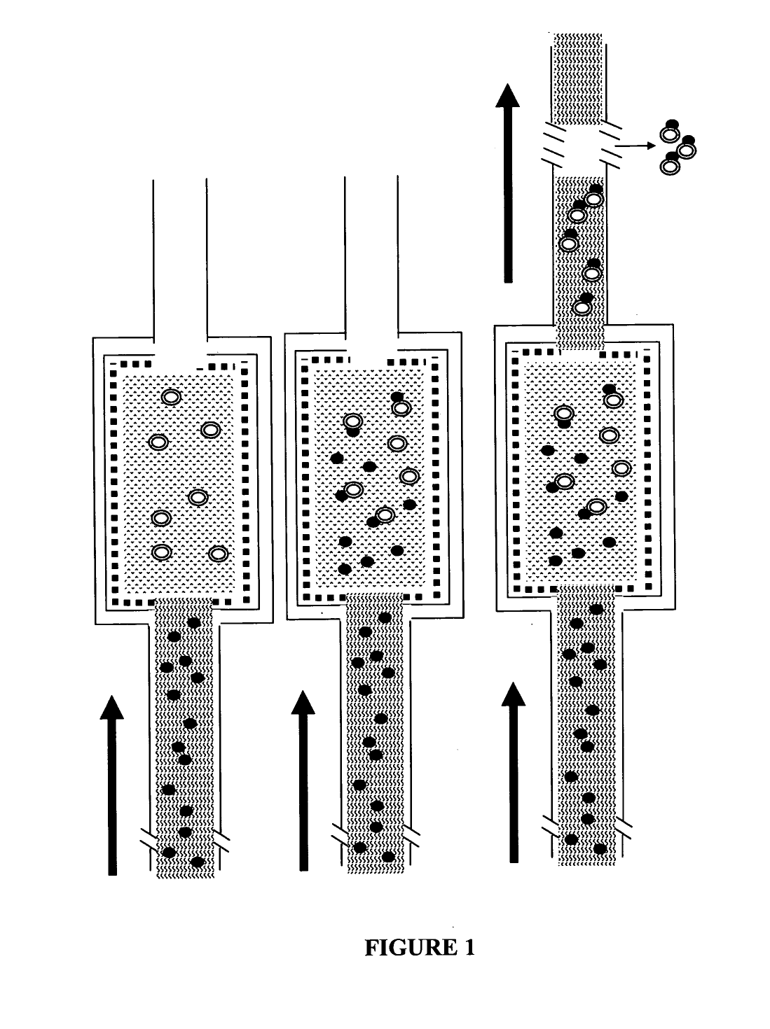

Biosynthesis of the catechol siderophore enterobactin in E. coli is a two-stage process involving the initial production of 2,3-dihydroxybenzoic acid (DHBA) from chorismate followed by the conversion of DHBA and L-serine to the active chelator siderophore form. See Ozenberger et al., J. Bacteriology, Vol. 171, No. 2, pp. 775-783 (1989). Three soluble enzymes are required for the initial stage, isochorismate synthetase, 2,3-dihy-dro-2,3-dihydroxybenzoate synthetase, and 2,3-dihy-dro-2,3-dihydroxybenzoate dehydrogenase. An enterobactin synthetase multienzyme complex of entD, entE, entF, and entG gene products helps catalyze the second stage of enterobactin biosynthesis. 1d. See also FIG. 1 of Ozenberger (Supra).

Accordingly, protein and encoding DNA sequences for various genes involved in enterobactin biosynthesis, and for synthesizing other siderophores, are known and can be exploited to create recombinant expression cassettes. These expression cassettes can be introduced into halophilic bacteria to express particular peptides, enzymes, or intermediary components that help boost or increase the levels of siderophores ultimately produced by the cell.

Siderophore-like peptides also can be made and used according to the methods disclosed herein. For instance, an 84-residue peptide—a microcin—produced by post-translation modifications that mimic catechol-like siderophore metal-binding properties have been reported. See Thomas et al., J. Biol. Chem., Vol. 279, No. 27, pp.: 28322-28242 (2004).

It is also possible to increase the expression of an endogenous siderophore by overexpressing or stimulating the activity of endogenous peptide synthetase enzymes that are in the siderophore production pathway. See, for instance, Devescovi et al., Systematic and Applied Microbiology, Volume 24, Issue 3, 2001, Pages 321-330 (2001), which described a siderophore peptide synthetase gene from plant-growth-promoting Pseudomonas putida.

Furthermore, the present methods use recombinant chimeric halophilic bacteria, which have multiple beneficial functions useful for decontaminating wastewater. For example, a halophilic bacteria that naturally degrades organophosphorous or aromatic compounds can be genetically engineered to overexpress a particular siderophore, such as a non-ribosomal peptitde, with metal-chelating properties, that it might not otherwise have normally expressed.

Another aspect of the methods disclosed herein includes simply the addition of pre-formed siderophores to wastewater without necessarily the need for a system, vessel, or device of halophilic bacteria to constantly produce siderophores. Thus, an aspect described herein is the addition of siderophores to any wastewater treatment system. Siderophores can be produced elsewhere by halophilic bacteria and isolated from them, concentrated, and then added directly to wastewater to chelate and bind contaminating metal ions.

With respect to the use of halophilic bacteria, however, these can be grown and stored in, or otherwise immobilized in, bioreactors, such as those described below, through which wastewater can be passed and thereafter purified by the chelating effects of the freshly secreted siderophores.

8. Bioreactors

A bioreactor is essentially a vessel, device, or system that supports a biologically active environment in which cells such as bacterial cells can survive in either aerobic or anaerobic conditions. Different types of bioreactors exist, such as those commonly known as batch bioreactors, fed batch bioreactors, or continuous bioreactors. Bioreactors can be useful for degrading contaminants in water with microorganisms through attached or suspended biological systems. In suspended growth systems, such as activated sludge, fluidized beds, or sequencing batch reactors, contaminated ground water is circulated in an aeration basin where a microbial population aerobically degrades organic matter and produces CO₂, H₂O, and new cells. The cells form a sludge, which is settled out in a clarifier, and is either recycled to the aeration basin or disposed. In attached growth systems, such as upflow fixed film bioreactors, rotating biological contactors (RBCS), and trickling filters, microorganisms are established on an inert support matrix to aerobically degrade water contaminants. See Ex Situ Biological Treatment, Section 4.41 Bioreactors at frtr.gov/matrix2/section4/4-42.html. See also Pilot Testing of a Membrane Bioreactor Treatment Plant for Reuse Applications (June 2008), New York State Energy Research and Development Authority.

Halophilic bacteria can be cultivated in such bioreactors and used to process phenol from brine by uptake. See, for instance, Woolard and Irvine, which described the use of a batch biofilm reactor, loaded with halophilic bacteria, that effectively absorbed (and therefore removed) 99% of contaminating phenol from hypersaline wastewater.

In a flow reactor where brine is washed past a population of halophilic bacteria, the metabolic complexors are swept away and bind with the heavy metals in the brine without carrying them back to the bacteria. The bacteria can continue producing more metabolites as long as they are fed. A corrosion-resistant bioreactor has been designed for the growth of halophilic bacteria, such as Archea bacteria, composed of polyetherether ketone (PEEK), tech glass and silicium nitrite ceramics. See Hezayen et al., Appl. Microbiol. Biotechnol. 54:319-325 (2000). Dincer and Kargi, Process Biochem., 36 (8-9), p. 9901-906 (2001) also described a rotating biological disc system for treating saline wastewater.

There exist various ways in which halophilic bacteria can be immobilized or attached to a surface in a bioreactor vessel, device, or system. One such way is by using membrane bioreactors, such as the ZeeWeed MBR bioreactor manufactured by General Electric. Such membrane bioreactor systems combine proven ultrafiltration technology with biological treatment for municipal, commercial and industrial wastewater treatment and water reuse applications. See gewater.com/products/equipment/mf_uf_mbr/mbr.jsp. Diaz et al., Biotechnol. Bioeng., 70(2): 145-53 (2002) also described immobilization of cells on polypropylene fibers. Bagai and Madamwar, Applied Biochemistry and Biotechnology, Vol. 62, Nos. 2-3 (March, 1997) described how Halobacterium salinarium cells were immobilized in calcium alginate beads and a polyvinyl alcohol film in order to improve the production of halophilica-amylase. The cells of Halobacterium salinarium were stabilized by cross-linking with glutaraldehyde. Onishi et al., General and applied aspects of halophilic microrganisms. Plenum Press, New York, N.Y., p. 341-349 (1991), described the use of flocculated cells of halophilic bacteria in a bioreactor column.

The latter flocculation technique is also useful for making biofilm reactors. Biofilm formation occurs when bacterial cells attach, or adsorb, to a support in aggregates, i.e., flocs, which ultimately form layers of cells known as biofilms. Ground glass and roughened polystyrene model stream beds were used to support mixed microbial biofilms capable of removing certain heavy metals from wastewaters. See Meyer and Wallis et al., Biotechnology Techniques, Vol. 11, No. 12, p. 859-863 (1997). See also See Qureshi et al., Microbial Cell Factories, 4:24 (2005). Qureshi describe that such biofilms can be used in various reactors, such as a batch reactor, continuous stirred tank reactor, packed bed reactor, fluidized bed reactor, airlift reactor, or upflow anaerobic sludge blanket reactor, to name a few.

With respect to the latter type, bioreactors that promote the creation of activated microorganism sludge is another widely used biological process for treating wastewater. For example, most municipal wastewater treatment plants employ the activated sludge process in their secondary treatment stage for removing organic pollutants from the wastewater. See U.S. Pat. No. 6,787,035. Conventional activated sludge processes can include a suspended-growth bioreactor through which wastewater flows. Air or oxygen is supplied to the aeration tank through an aeration system and, in the tank, pollutants are either degraded or adsorbed by the activated microorganism sludge.

There also exist other immobilized cell reactors, where cells are fixed onto various supports by entrapment or by covalent bonding. These methods of cellular immobilization typically require the use of chemicals to fix the cells to a support but they are highly productive and provide high cell concentrations. According to the present methods, halophilic bacteria can be grown into biofilm supports such as charcoal, resin, bonechar, concrete, clay brick, or sand particles. See Qureshi et al. (supra). Bacterial can bind to surfaces or aggregate together via extracellular polymeric substances, such as exopolysaccharide alginate, that interact with the surface of a support or with another cell surface. A bioreactor that is rich in nutrients also helps promote rapid growth of biofilms and sustain the viability of bacterial cell. Alternatively, the cells themselves may aggregate/floc together to form biomass particles, which grow over time, in the bioreactor, and which is known as a granular biofilm reactor.

Typically, wastewater also contains organic nitrogen, ammonia, and phosphorus, which are beneficial to microorganisms as nutrients to sustain growth and survival and also therefore promote sludge formation. Thus, the presence of certain bacteria in the bioreactor can help remove such nutrients from wastewater in a process called nitrification. If the bioreactor is under anoxic or anaerobic conditions, microorganisms can reduce the nitrate and nitrite to nitrogen gas (de-nitrification).

A method of the present technology entails the use of a halophile-populated bioreactor that produces siderophores in the bioreactor, which are carried away from the immobilized, entrapped, adsorbed, or biofilm, bacteria by the wastewater that is constantly flowing through the bioreactor. The siderophores are able to chelate metal ions present in the wastewater. Because, according to the present methods, the siderophores are carried out of the halophile-containing bioreactor and into a separate and distinct vessel, device, or treatment system, there is little, if any, possibility that a siderophore can effectively return the chelated metal to the immobilized halophiles for assimilation. Thus, the present method and composition is new and different from existing bioreactor sewage treatment systems in which the polluting compounds are digested and remain within the bacterial or microorganism-located portion of the bioreactor, e.g., as activated sludge. By contrast an aspect of the present method uses halophilic bacteria as cellular factories for producing metal-chelating siderophores, which complex with pollutant metal ions present in the wastewater and do not return to the halophiles in the bioreactor.

Accordingly, a wastewater treatment system described herein comprises an inlet to a bioreactor that houses immobilized, attached, or suspended halophilic bacteria that naturally, or recombinantly, produce and secrete siderophores, and an outlet from that bioreactor. In one embodiment, wastewater constantly flows through the inlet and out through the outlet, while passing constantly through or over the halophiles located in the bioreactor. The outflow of wastewater therefore contains siderophores that can complex and chelate metal ions, such as heavy metals, present in the oufflowing wastewater. In another embodiment, a dedicated stream of liquid containing siderophores can be used to carry or introduce siderophores into wastewater located elsewhere. Thus, as disclosed elsewhere herein, it is not necessary, according to the present technology, for an aqueous medium such as wastewater, to be brought into contact with, or flowed through, across, or over, immobilized siderophore-secreting microorganisms, such as immobilized halophilic bacteria. Accordingly, it is not necessary that the to-be-treated medium, such as wastewater, flow into and out of a bioreactor or similar chamber in which is contained siderophore-producing microorganisms.

In a situation in which wastewater is passed through the bioreactor, then, in the case of brine, for instance, brine wastewater can be passed into a halophilic bioreactor such that the brine outflow contains siderophores that bind to sodium in the briny salt and thereby chelate the sodium into complexes that can then be removed or otherwise filtered from the brine wastewater to reduce the salt content. Examples of how such biosorbed siderophore-metal complexes can then be removed from the wastewater as described in the following section.

9. Removal of Biosorbed Heavy Metal Complexes

Where the heavy metals in the solids are excessively high and limit the use of the solids for land application, these heavy metals are removed either by precipitation at high pH with lime and separation or by acid leaching them into the liquid fraction by a sulfurous acid wastewater treatment. To remove these heavy metals from the liquid fraction, the pH of the separated treated wastewater is raised sufficiently to precipitate those heavy metals contained in the wastewater as metal hydroxides for filtration removal via belt presses or tighter weave polyethylene woven bags or other filtration means.

Removal can occur by a variety of methods. One method is flocculation, where the metabolites are induced to form larger structures then filtered by coarse filters or allowed to settle out. Example flocculants might be anything that bond to the OH groups on the rings. See FIG. 1. For instance, certain chemicals can be used as flocculants, such as, but not limited to alum, aluminium chlorohydrate, aluminium sulfate, calcium oxide, calcium hydroxide, iron(II) sulfate, iron(III) chloride, polyacrylamide, polyDADMAC, sodium aluminate, and sodium silicate. Some natural products also are known to be useful flocculant agents, including but not limited to chitosan, isinglass, Moringa oleifera seeds (Horseradish Tree), gelatin, Strychnos potatorum seeds (Nirmali nut tree), Guar gum, and alginates (brown seaweed extracts). Flocculation also is known as agglomeration and coagulation. Agglomeration is defined as the process of contact and adhesion whereby dispersed particles are held together by weak physical interactions ultimately leading to phase separation by the formation of precipitates of larger than colloidal size. See goldbook.iupac.org/A00182.html (PAC, 2007, 79, 1801 (Definitions of terms relating to the structure and processing of sols, gels, networks, and inorganic-organic hybrid materials (IUPAC Recommendations 2007)) on page 1821), which is incorporated herein by reference.

Alternatively, a ploy(amine) can be injected into the system, so that a very cheap polymer can provide the flocculant. Such polymers do not have a high attraction to metals on their own but can be used to effectively “floc out” the siderophore-metal complex.

10. Recovery of Metals

Not only are the present methods useful for removing metal ions from wastewater, but the heavy metals that are subsequently removed from the siderophore-chelating complex can thereafter be recovered for industrial use. Thus, the present methods can be used affirmatively to recover certain types of metals present in any kind of water, not only wastewater. For instance, if it is known that a particular point source of water contains high levels of a particular metal, then a bioreactor system as described herein can be used to treat that point source water and effectively chelate-out the desired metal ions. Indeed, a bioreactor can be designed to hold and sustain the growth of certain halophilic bacteria that produce siderophores with a strong chelating affinity for particular metal ions. For example, species of Pseudomonas, which secrete pycocyanin and pyoverdin siderophores, can be cultured in a bioreactor to specifically chelate and bind to iron ions present in water. Non-point source water that flows over natural surfaces rich in certain types of metals can also be treated in this way. For instance, road and highway surfaces can contain high levels of certain heavy metal ions due to waste pollutants deposited from cars, tires, fuel, gas, and emissions. The present methods can be applied to treat non-point source runoff waters contaminated with metal ions by ensuring drainage systems contain a halophilic bioreactor through which the drainage water first passes prior to further treatment.

11. National Pollutant Discharge Elimination System

The U.S. National Pollutant Discharge Elimination System (NPDES) issues permits to all wastewater dischargers and treatment facilities. These permits establish specific discharge limits, monitoring and reporting requirements and may also require these facilities to undertake special measures to protect the environment from harmful pollutants. The methods, halophiles, compositions, and bioreactors described herein can therefore be used to help meet the NPDES purification requirements and permits.

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 particles refers to groups having 1, 2, or 3 particles. Similarly, a group having 1-5 particles refers to groups having 1, 2, 3, 4, or 5 particles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

All references cited herein are incorporated by reference in their entireties and for all purposes to the same extent as if each individual publication, patent, or patent application was specifically and individually incorporated by reference in its entirety for all purposes.

1. A method for removing metals from a liquid, comprising:
exposing a liquid to siderophores, which chelate metal ions present in the liquid to form a siderophore-metal complex, wherein the siderophores are not immobilized; and
removing the siderophore-metal complex from the siderophore liquid mixture.

2. The method of claim 1, wherein the liquid is exposed to siderophores by passing the liquid over at least one surface on which are immobilized microorganisms that produce and secrete the siderophores.

3. The method of claim 2, wherein the surface is one or more internal surfaces of a compartment, wherein the compartment has an inlet and outlet to allow the passage of liquid through the compartment.

4. The method of claim 3, wherein the compartment is, or is part of, a bioreactor.

5. The method of claim 2, wherein the surface is of one or more removable structures that can be positioned directly in the flow of the liquid.

6. The method of claim 4, wherein the structure is a membrane, cloth, or filter.

7. The method of claim 1, wherein the liquid is wastewater.

8. The method of claim 7, wherein the wastewater is brine or hypersalinated water.

9. The method of claim 2, wherein the microorganisms are halophilic bacteria.

10. The method of claim 9, wherein the bacteria is an enteric bacteria.

11. The method of claim 10, wherein the siderophore is enterobactin.

12. The method of claim 9, wherein the cells of the bacteria are recombinantly engineered to express a different siderophore or a different level of siderophore than is normally expressed in cells of a non-recombinant bacteria.

13. The method of claim 1, wherein the siderophore is selected from the group consisting of: enterobactin, enterochelin, aerobactin, agrobactin, pyochelin, pyoverdine, pseudobactins, ferribactin, schizokinen, arthrobactin, α-e-bis-2,3-dihydroxybenzoyllysine, ferrioxamines, mycobactins, and catecholate type siderophores.

14. The method of claim 1, wherein the siderophore is selected from the group consisting of ferrichromes, copragen, rhodotorulic acids, and hydroxamate type, siderophores.

15. The method of claim 1, wherein the siderophores are directly added to the liquid.

16. The method of claim 1, wherein a liquid which comprises siderophores is flowed into the metal-containing liquid, whereupon the siderophores chelate to metals present in the metal-containing liquid.

17. A wastewater treatment system, comprising:
an inlet to a bioreactor in which halophilic bacteria are grown and maintained that secrete siderophores, and
an outlet from that bioreactor.

18. A method for removing metal ions from brine, comprising:
passing brine through a bioreactor that comprises siderophore-secreting halophilic bacteria, wherein the outflow of brine from the bioreactor contains secreted siderophores that chelate sodium metal ions, and
removing the sodium-siderophore chelated complex from the outflowing wastewater.

19. The method of claim 1, further comprising purifying the metals from the siderophore-metal complex.

20. The wastewater treatment system of claim 17, wherein the siderophore is selected from the group consisting of: enterobactin, enterochelin, aerobactin, agrobactin, pyochelin, pyoverdine, pseudobactins, ferribactin, schizokinen, arthrobactin, α-e-bis-2,3-dihydroxybenzoyllysine, ferrioxamines, mycobactins, ferrichromes, copragen, rhodotorulic acids, hydroxamate type siderophores, and catecholate type siderophores.
